(19) United States
(12) Patent Application Publication
(10) Pub. No.: US 2007/0138783 A1
(43) Pub. Date: Jun. 21, 2007

(54) Guide for seat belt webbing having a deformable insert

(75) Inventors: Michael P. Gleason, Chesterfield, MI (US); Chhay Siev, Macomb, MI (US); Thomas Opalewski, Metamora, MI (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Vehicle Safety Systems Inc.

(21) Appl. No.: 11/313,081

(22) Filed: Dec. 20, 2005

(51) Int. Cl. B60R 22/00

(52) U.S. Cl. 280/808; 297/483

(57) ABSTRACT

A guide (34a) for seat belt webbing (16) in a vehicle (14) includes a support member (50) that includes an elongated slot (88) through which the seat belt webbing (16) extends. A curved surface (90) defines a portion of the elongated slot (88). The guide (34a) also includes an insert (110) that is adapted to be received in the elongated slot (88) of the support member (50) and that includes a webbing guide portion (112) for guiding the seat belt webbing (16) through the elongated slot (88). The webbing guide portion (112), during normal operating conditions, is spaced apart from the curved surface (90) of the support member (50). The webbing guide portion (112) of the insert (110), when subjected to a load from the seat belt webbing (16) that exceeds a predetermined amount, moves into engagement with and conforms to the curved surface (90) of the support member (50).

### TECHNICAL FIELD

The present invention relates to a guide for seat belt webbing. More particularly, the present invention relates to a guide for seat belt webbing having an insert that deforms when subjected to a predetermined load from the seat belt webbing.

### BACKGROUND OF THE INVENTION

A three-point seat belt system typically includes a D-ring that is mounted to structure of the vehicle. Seat belt webbing of the three-point seat belt system extends from a retractor and through the D-ring. The D-ring includes a guide bar over which the seat belt webbing turns as it passes through the D-ring.

Tension in the seat belt webbing applies a load to the D-ring. The D-ring transfers the load to the structure of the vehicle. For example, during a frontal vehicle crash condition in which an occupant of a seat is restrained by the seat belt system, the retractor of the seat belt system locks to prevent the withdrawal of the seat belt webbing. Due to inertia, the occupant tends to move forward relative to the seat. The forward movement of the occupant tensions the seat belt webbing. The tensioned seat belt webbing applies a load to the D-ring. The D-ring transfers the load to the structure of the vehicle.

The direction in which the load is applied to the D-ring varies dependent upon the crash conditions, the size of the occupant, the location of the D-ring relative to the seat, and other variables. Since the load may be applied to the D-ring in various directions, the D-ring is generally pivotable relative to the structure of the vehicle. The pivoting movement of the D-ring helps to maintain a position of the seat belt webbing relative to the guide bar of the D-ring.

Seat belt webbing, when viewed in section, preferably extends flat across the guide bar of the D-ring. When extending flat across the guide bar, the seat belt webbing is evenly loaded across its width and distributes the load evenly along the guide bar of the D-ring. A phenomenon known as “dumping” may occur with the seat belt webbing passing through a D-ring. Dumping is the bunching together of the seat belt webbing at one end of a webbing slot of a D-ring through which the seat belt webbing extends. When dumping occurs, the seat belt webbing may be loaded unevenly. The dumped seat belt webbing concentrates the load on a particular portion of the D-ring.

The tendency of the seat belt webbing to dump increases as the friction between the webbing and the guide bar of the D-ring decreases. There is a desire, however, to provide the guide bar of the D-ring with a low friction surface so that the effort required for an occupant to pull the seat belt webbing through the D-ring is low.

Also, the smaller the distance between the guide bar of the D-ring and the pivot point of the D-ring, which is typically the center of a bolt hole, the greater the tendency for the seat belt webbing to dump. As the distance between the guide bar and the pivot point increases, the moment created by the tension in the seat belt webbing and acting to pivot the D-ring increases. As the moment acting to pivot the D-ring increases, dumping of the seat belt webbing is less likely to occur.

### SUMMARY OF THE INVENTION

The present invention relates to a guide for seat belt webbing in a vehicle. The guide comprises a support member that is adapted to be mounted to the vehicle and that includes an elongated slot through which the seat belt webbing extends. A curved surface defines a portion of the elongated slot. The guide also comprises an insert that is adapted to be received in the elongated slot of the support member and that includes a webbing guide portion for guiding the seat belt webbing through the elongated slot. The webbing guide portion, during normal operating conditions, is spaced apart from the curved surface of the support member. The webbing guide portion of the insert, when subjected to a load from the seat belt webbing that exceeds a predetermined amount, moves into engagement with and conforms to the curved surface of the support member.

According to another aspect, the present invention relates to a guide for seat belt webbing in a vehicle. The guide comprises a support member that is adapted to be mounted to the vehicle and that includes an elongated slot through which the seat belt webbing extends. The guide also comprises an insert that is adapted to be received in the elongated slot of the support member and that includes a webbing guide portion for guiding the seat belt webbing through the elongated slot. The webbing guide portion, during normal operating conditions, extends longitudinally through the elongated slot so that the seat belt webbing extending through the elongated slot is generally flat. The webbing guide portion deforms into a curved configuration when subjected to a load from the seat belt webbing that exceeds a predetermined amount so that the seat belt webbing extending through the elongated slot also is curved.

### BRIEF DESCRIPTION OF THE DRAWINGS

The foregoing and other features of the present invention will become apparent to those skilled in the art to which the present invention relates upon reading the following description with reference to the accompanying drawings, in which:

FIG. 1 is a schematic illustration of a vehicle seat belt system including a guide constructed in accordance with the present invention;

FIG. 2 is an exploded perspective view of a guide constructed in accordance with a first embodiment of the present invention;

FIG. 3 is an elevation view of the guide of FIG. 2 under normal operating conditions;

FIG. 4 is a view taken along line 4-4 in FIG. 3;

FIG. 5 is an elevation view of the guide of FIG. 2 when subjected to a load from the seat belt webbing that exceeds a predetermined amount;

FIG. 6 is a view taken along line 6-6 in FIG. 5;

FIG. 7 is an elevation view, partially in section, of a guide constructed in accordance with a second embodiment of the present invention and under normal operating conditions;

FIG. 8 is an elevation view, partially in section, of the guide of FIG. 7 when subjected to a load from the seat belt webbing that exceeds a predetermined amount;

FIG. 9 illustrates an alternative base plate that may be used with the guide of FIG. 7;

FIG. 10 is an elevation view, partially in section, of a guide constructed in accordance with a third embodiment of the present invention;

FIG. 11 is an exploded perspective view of a guide constructed in accordance with a fourth embodiment of the present invention;

FIG. 12 is a perspective view of the guide of FIG. 11 in an assembled condition and under normal operating conditions;

FIG. 13 is a perspective view of the guide of FIG. 11 in an assembled condition and subjected to a load from the seat belt webbing that exceeds a predetermined amount;

FIG. 14 is an exploded perspective view of a guide constructed in accordance with a fifth embodiment of the present invention;

FIG. 15A is a partial perspective view of the guide of FIG. 14;

FIG. 15B is a partial perspective view of the guide of FIG. 14 viewed from the direction of line 15B-15B of FIG. 15A;

FIG. 15C is a partial perspective view of the guide of FIG. 14 viewed from the direction of line 15C-15C of FIG. 15A;

FIG. 16 is a perspective view of the guide of FIG. 14 in an assembled condition and under normal operating conditions;

FIG. 17 is a perspective view of the guide of FIG. 14 in an assembled condition and subjected to a load from the seat belt webbing that exceeds a predetermined amount; and

FIG. 18 is a view taken along line 18-18 of FIG. 17.

### DETAILED DESCRIPTION OF THE INVENTION

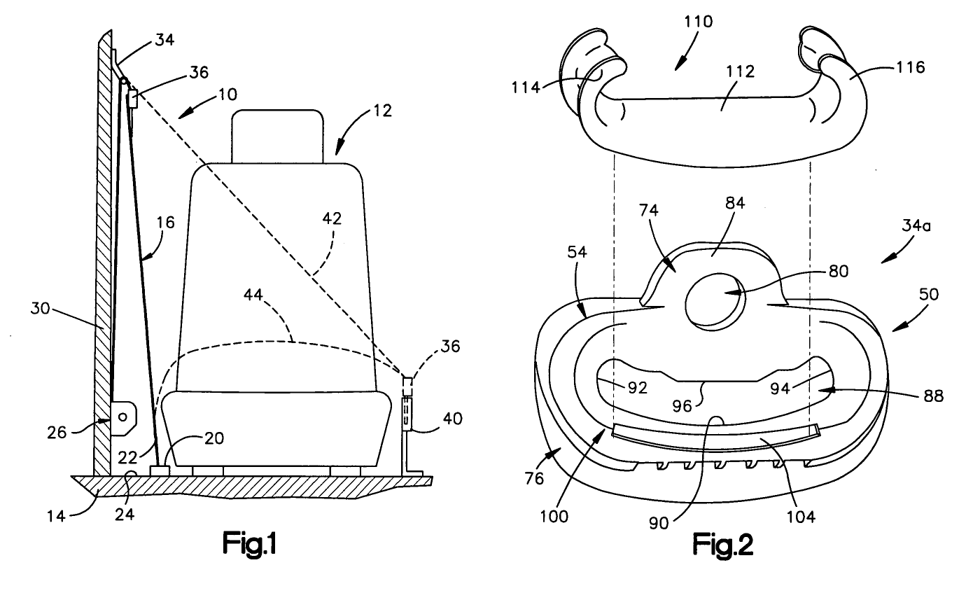

FIG. 1 illustrates a three-point continuous loop seat belt system 10 for use in helping to protect an occupant (not shown) of a seat 12 of a vehicle 14. The seat belt system 10 includes a length of seat belt webbing 16. An anchor 20 fixes a first end 22 of the seat belt webbing 16 to the floor 24 of the vehicle 14 on a left side, as viewed in FIG. 1, of the seat. A second end (not shown) of the seat belt webbing 16 is fixed to a retractor 26. FIG. 1 illustrates the retractor 26 secured to the B-pillar 30 of the vehicle 14 adjacent to the left side of the seat, as viewed in FIG. 1.

The seat belt system 10 of FIG. 1 also includes a guide 34 constructed in accordance with the present invention. The guide 34 illustrated in FIG. 1 is a D-ring assembly. The guide 34 is secured to the B-pillar 30 in a location spaced above the retractor 26.

The seat belt webbing 16 of the seat belt system 10 extends upwardly from the retractor 26 and through the guide 34. The seat belt webbing 16 then extends downwardly from the guide 34 to the anchor 20. A tongue assembly 36 is located on the seat belt webbing 16 between the guide 34 and the anchor 20. The tongue assembly 36 is movable along the seat belt webbing 16. The seat belt system 10 also includes a buckle assembly 40. The buckle assembly 40 is anchored to the floor 24 of the vehicle 14 on the right side of the seat 12, as viewed in FIG. 1.

When the seat belt system 10 is not in use, the seat belt webbing 16 is oriented generally vertically on the left side of the seat 12, as is shown in FIG. 1 by solid lines. To engage the seat belt system 10, the tongue assembly 36 is manually grasped and is pulled across the occupant of the seat 12. As the tongue assembly 36 is pulled across the occupant, the tongue assembly 36 moves along the seat belt webbing 16 and seat belt webbing is withdrawn from the retractor 26. The movement of the tongue assembly 36 across the occupant pulls the seat belt webbing 16 across the lap and torso of the occupant. After the seat belt webbing 16 has been pulled across the lap and torso of the occupant, the tongue assembly 36 is inserted into the buckle assembly 40 and is latched in the buckle assembly. When the tongue assembly 36 is latched in the buckle assembly 40, the seat belt webbing 16 is in the position shown in FIG. 1 by dashed lines.

When the tongue assembly 36 is latched in the buckle assembly 40, the tongue assembly 36 divides the seat belt webbing 16 into a torso portion 42 and a lap portion 44. The torso portion 42 of the seat belt webbing 16 extends between the guide 34 and the tongue assembly 36 and extends across the torso of the occupant of the seat 12. The lap portion 46 of the seat belt webbing 16 extends between the tongue assembly 36 and the anchor 20 and extends across the lap of the occupant of the seat 12.

FIG. 2 is an exploded perspective view of a guide 34a constructed in accordance with a first embodiment of the present invention. The guide 34a of FIG. 2 may form the guide 34 of the seat belt system 10 illustrated in FIG. 1.

The guide 34a includes a support member 50. The support member 50 of the guide 34a is adapted to withstand extremely high loads and to maintain structural integrity at temperature extremes. As shown with reference to FIG. 4, the support member 50 includes a metal base plate 52 and a plastic covering 54. The metal base plate 52 is preferably stamped from steel and includes a mounting portion 58 and a webbing support portion 60. The metal base plate 52 is angled at a transition between the mounting portion 58 and the webbing support portion 60.

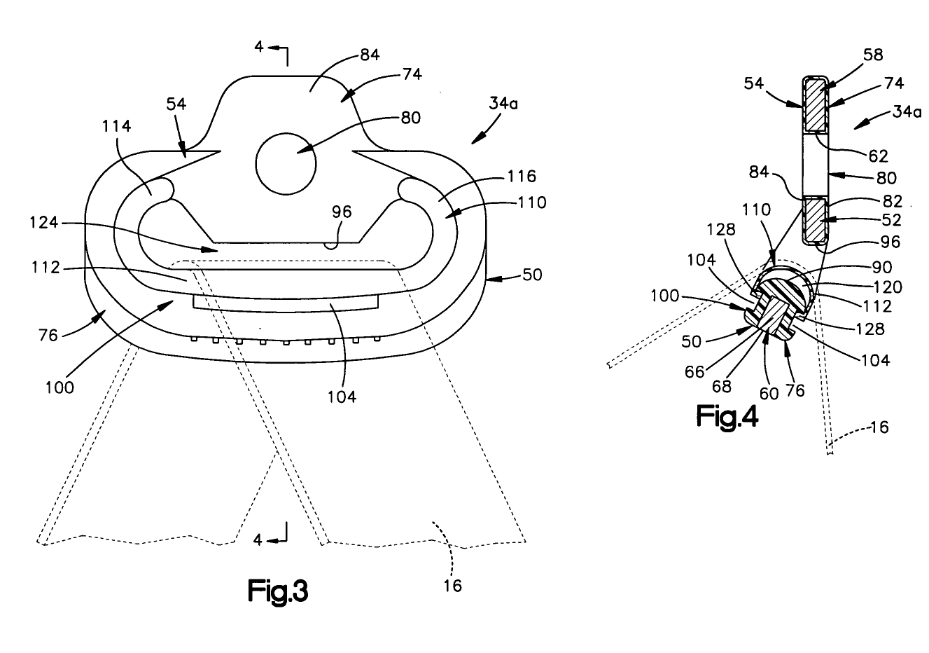

The mounting portion 58 of the metal base plate 52 is generally trapezoidal, as can be seen with reference to FIG. 3. An aperture 62, shown in FIG. 4, extends through the center of the mounting portion 58. The webbing support portion 60 of the metal base plate 52 is oval. An elongated slot extends through the center of the webbing support portion 60. A guide bar portion 66 (FIG. 4) of the metal base plate 52 defines a lowermost edge of the elongated slot.

The plastic covering 54 of the support member 50 is preferably insert molded onto the metal base plate 52. The plastic covering 54 is preferably formed from nylon 6/6. As shown in FIG. 4, the plastic covering 54 covers all of the metal base plate 52 with the exception of a portion of a lower surface 68 of the metal base plate.

The plastic covering 54 also includes a mounting portion 74 and a webbing support portion 76. The mounting portion 74 of the plastic covering 54 is trapezoidal and overlies the mounting portion 58 of the metal base plate 52. The webbing support portion 76 of the plastic covering 54 is oval and overlies the webbing support portion 60 of the metal base plate 52.

The mounting portion 74 of the plastic covering 54 extends through the aperture of 62 the metal base plate 52 and defines a smaller diameter aperture 80. The aperture 80 extends between inner and outer surfaces 82 and 84 (FIG. 4), respectively, of the plastic covering 54. When the guide 34a is mounted to the vehicle 14, the inner surface 82 of the plastic covering 54 is nearer the structure of the vehicle than the outer surface 84. The aperture 80 is sized for receiving a fastener (not shown) for pivotally mounting the guide 34a to structure of the vehicle 14, such as the B-pillar 30 of FIG. 1.

The webbing support portion 76 of the plastic covering 54 extends through the elongated slot of the metal base plate 52 and defines an elongated slot 88 (FIG. 2) of the support member 50. As shown in FIG. 2, a curved lower surface 90, first and second side surfaces 92 and 94, respectively, and an upper surface 96 of the plastic covering 54 define the elongated slot 88.

The curved lower surface 90 has a radius of curvature that is significantly greater than the distance between the curved lower surface and the center of the aperture 80. The curved lower surface 90 extends across the width of the support member 50, from left to right as viewed in FIG. 2, and defines the lowermost portion of the elongated slot 88. As FIG. 4 illustrates, the curved lower surface 90 has a generally rounded profile extending from the side of the support member 50 presented to the interior of the vehicle 14 to the side of the support member presented to the exterior of the vehicle.

As shown in FIG. 4, a guide bar portion 100 of the plastic covering 54 is associated with and overlies the guide bar portion 66 of the metal base plate 52. The curved lower surface 90 of the plastic covering 54 forms an uppermost surface of the guide bar portion 100. As FIG. 4 illustrates, the guide bar portion 100 of the plastic covering 54 has an increased thickness, as compared to the remainder of the plastic covering. Elongated recesses 104 extend into the inner and outer surfaces 82 and 84 on the guide bar portion 100 of the plastic covering 54. The recesses 104 are elongated in a direction across the width of the support member 50 from left to right, as shown in FIG. 2 with reference to the recess 104 in the outer surface 84.

The guide 34a also includes an insert 110 (FIG. 2). As shown in FIG. 2, the insert 110 includes a webbing guide portion 112 that is interposed between curved end portions 114 and 116, respectively. The insert 110 is injection molded and includes a generally rounded profile, when viewed in cross-section as illustrated in FIG. 4. The insert 110 is shaped like a straight section of tubing that is cut longitudinally in half and then has longitudinally opposite ends curled upwardly to form the curved end portions 114 and 116. The insert 110 is formed from a low friction and generally resilient material, such as Bexloy, a modified ionomer resin manufactured by E.I. DuPont de Nemours & Co. of Wilmington, Del. The rounded profile of the insert 110 defines an inner cavity 120 (FIG. 4). The inner cavity 120 is sized for receiving the guide bar portion 100 of the plastic covering 54.

The insert 110 is adapted to snap into the elongated slot 88 of the support member 50. When snapping into the elongated slot 88, the curved end portions 114 and 116 of the insert 110 bend toward the webbing guide portion 112 to enable the insert to pass into the elongated slot 88. When located in the elongated slot 88, the curved end portions 114 and 116 return to their original positions relative to the webbing guide portion 112 and overlie portions of the plastic covering 54 located on longitudinally opposite ends of the elongated slot 88.

When received in the elongated slot 88, the webbing guide portion 112 of the insert 110 extends along the elongated slot 88 between the first and second side surfaces 92 and 94 and generally parallel to the upper surface 96, as shown in FIG. 3. A narrow channel 124 (FIG. 3) is defined between the webbing guide portion 112 of the insert 110 and the upper surface 96 for receiving the seat belt webbing 16.

As shown in FIG. 4, leg portions 128 extend into the inner cavity 120 from opposite edges of the webbing guide portion 112 of the insert 110. When the insert 110 in received in the elongated slot 88 of the support member 50, the leg portions 128 snap into the recesses 104 of the guide bar portion 100.

The webbing guide portion 112 of the insert 110 provides a low friction surface over which the seat belt webbing 16 moves when moving through the guide 34a. With reference to FIG. 1, the webbing guide portion 112 provides a turning surface to guide or redirect the seat belt webbing 16 between an upwardly extending portion located between the retractor 26 and the guide 34 and a generally downward extending portion located between the guide 34 and either the anchor 20 or the buckle assembly 40. As FIG. 3 illustrates, the seat belt webbing 16, when extending over the webbing guide portion 112, is generally flat.

Circumstances may arise when the seat belt webbing 16 is subjected to high loads, such as when restraining an occupant during the occurrence of a vehicle crash condition. A portion of the load applied to the seat belt webbing 16 is transferred to the vehicle structure through the guide 34a. Specifically, the load applied to the seat belt webbing 16 results in tensioning of the seat belt webbing. The tension of the seat belt webbing applies a load to the guide 34a. The guide 34a transfers the load to the vehicle structure. The guide 34a of the present invention is adapted to withstand high loads from the seat belt webbing 16 while simultaneously preventing dumping of the seat belt webbing.

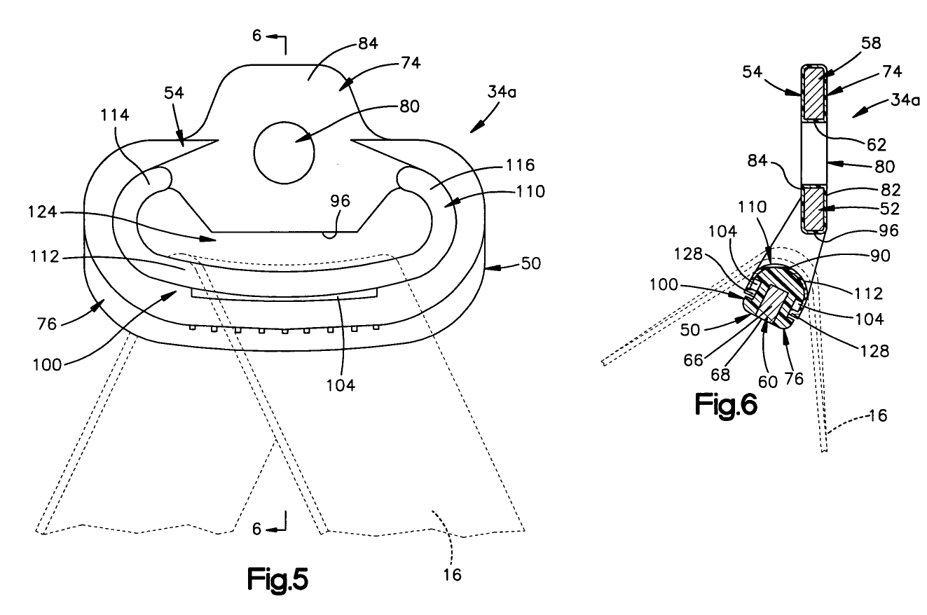

When the seat belt webbing 16 applies a load in excess of a predetermined amount to the webbing guide portion 112 of the insert 110 of the guide 34a, the webbing guide portion 112 deforms. During deformation, the webbing guide portion 112 conforms to the shape of the curved lower surface 90 of the plastic covering 54 of the support member 50, as shown in FIGS. 5 and 6. As the webbing guide portion 112 moves downwardly into the curved configuration illustrated in FIG. 5, the leg portions 128 of the insert 110 slide downwardly in the recesses 104 of the guide bar portion 100 of the plastic covering 54. The downward movement of the webbing guide portion 112 increases the distance between a center of the aperture 80, i.e., the pivot point of the guide 34a, and the webbing guide portion 112. This increased distance helps to reduce the tendency of the seat belt webbing 16 to dump. Additionally, the curved configuration of the webbing guide portion 112, when conforming to the curved lower surface 90, caused the seat belt webbing extending over the webbing guide portion 112 to curve, as shown in FIG. 5. The curving of the seat belt webbing helps reduces the tendency of the seat belt webbing 16 to slide toward the curved end portions 114 and 116 of the insert 110 so as to further reduce the tendency of the seat belt webbing to dump.

When the load applied to the seat belt webbing 16 decreases, the load applied to the insert 110 of the guide 34a also decreases. When the load applied to the insert 110 is reduced below the predetermined amount, the resiliency of the insert 110 causes the insert to return to its original shape within the elongated slot 88.

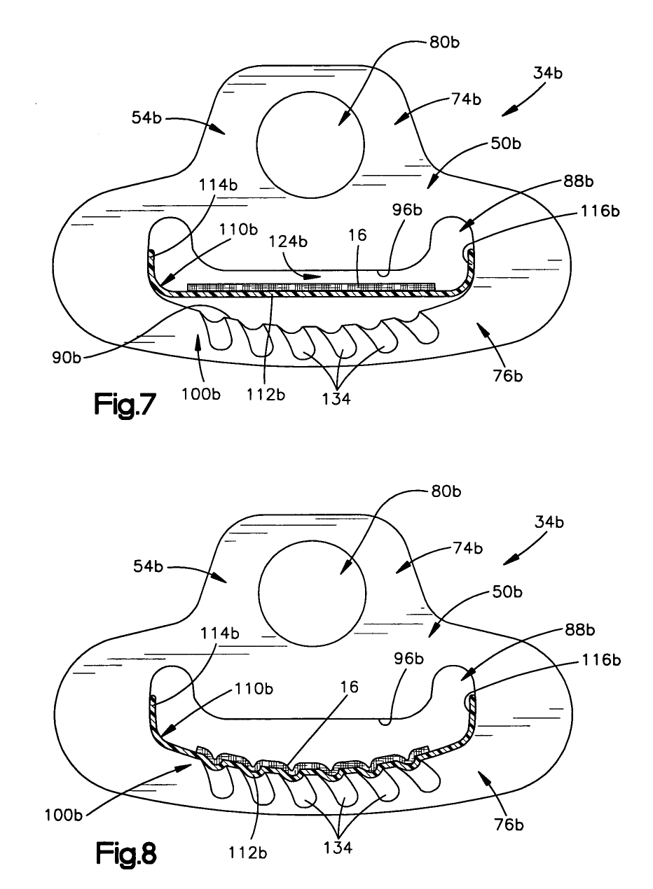

FIG. 7 is an elevation view, partially in section, of a guide 34b constructed in accordance with a second embodiment of the present invention. The guide 34b may form the guide 34 of the seat belt system 10 illustrated in FIG. 1. The guide 34b is similar to the guide 34a. Features of the guide 34b that are the same as or similar to those described with reference to the guide 34a of FIGS. 2-6 are labeled with the same reference numbers with the addition of the suffix “b”.

The guide 34b includes a support member 50b. The support member 50b of the guide 34b is adapted to withstand extremely high loads and to maintain structural integrity at temperature extremes. The support member 50b is similar to the support member 50 of FIGS. 2-6 and includes a metal base plate (not shown) and a plastic covering 54b. The plastic covering 54b of the support member 50b is preferably insert molded onto the metal base plate and includes a mounting portion 74b and a webbing support portion 76b.

An aperture 80b extends through the mounting portion 74b of the plastic covering 54b. The aperture 80b is sized for receiving a fastener (not shown) for pivotally mounting the guide 34b to the vehicle 14. The webbing support portion 76b of the plastic covering 54b defines an elongated slot 88b of the support member 50b. The elongated slot 88b includes a curved lower surface 90b (FIG. 7). The curved lower surface 90b has a radius of curvature that is significantly greater than the distance between the curved lower surface and the center of the aperture 80b. The curved lower surface 90b extends across the width of the support member 50b, from left to right as viewed in FIG. 7, and defines the lowermost portion of the elongated slot 88b. The curved lower surface 90b forms an uppermost surface of a guide bar portion 100b of the plastic covering 54b.

Multiple angled grooves 134 extend into the curved lower surface 90b. The embodiment of FIG. 7 illustrates six angled grooves 134. The angled grooves 134 extend in a direction generally parallel to the direction that the seat belt webbing 16 extends over the curved lower surface 90b.

The guide 34b also includes an insert 110b. A sectional view of the insert 110b is shown in FIG. 7. The insert 10b includes a webbing guide portion 112b that is interposed between end portions 114b and 116b. The end portions 114b and 116b extend upwardly from the webbing guide portion 112b, as viewed in FIG. 7, and are oriented generally perpendicular to the webbing guide portion. The insert 10b is injection molded and has a generally rounded profile, similar to the profile of the insert 110 illustrated in FIG. 4.

The insert 110b is formed from a low friction and generally resilient material, such as Bexloy, a modified ionomer resin manufactured by E.I. DuPont de Nemours & Co. of Wilmington, Del. The rounded profile of the insert 110b defines an inner cavity (not shown) that is sized for receiving the guide bar portion 100b of the plastic covering 54b.

The insert 110b is adapted to snap into the elongated slot 88b of the support member 50b. When snapping into the elongated slot 88b, the end portions 114b and 116b of the insert 10b bend toward the webbing guide portion 112b to enable the insert to pass into the elongated slot 88b. When located in the elongated slot 88b, the end portions 114b and 116b return to their original positions relative to the webbing guide portion 112b and overlie portions of the plastic covering 54b located at longitudinally opposite ends of the elongated slot 88b.

As shown in FIG. 7, when the insert 10b is received in the elongated slot 88b of the support member 50b, the webbing guide portion 112b of the insert 10b extends generally parallel to the upper surface 96b of the plastic covering 54b. A narrow channel 124b for receiving seat belt webbing 16 is defined between the webbing guide portion 112b of the insert 10b and the upper surface 96b of the plastic covering.

The webbing guide portion 112b of the insert 110b provides a low friction surface over which the seat belt webbing 16 moves when moving through the guide 34b. As FIG. 7 illustrates, the seat belt webbing 16 is generally flat when extending through the elongated slot 88b over the webbing guide portion 112b of the insert 110b. Circumstances may arise when the seat belt webbing 16 is subjected to high loads, such as when restraining an occupant during the occurrence of a vehicle crash condition. A portion of the load of the seat belt webbing 16 is transferred to the vehicle structure through the guide 34b. The guide 34b of the present invention is adapted to withstand high loads from the seat belt webbing 16 while simultaneously preventing dumping of the seat belt webbing.

When the seat belt webbing 16 applies a load in excess of a predetermined amount to the webbing guide portion 112b of the insert 10b, the webbing guide portion 112b deforms. During deformation, the webbing guide portion 112b conforms to the shape of the curved lower surface 90b. As shown in FIG. 8, when the insert 110b conforms to the shape of the curved lower surface 90b, portions of the insert 110b deform into the angled grooves 134. The end portions 114b and 116b of the insert 110b, which overlie portions of the plastic covering 54b at longitudinally opposite ends of the elongated slot 88b, secure the insert in the elongated slot during the deformation of the webbing guide portion 112b into the curved configuration of FIG. 8.

When the webbing guide portion 112b moves downward to conform to the shape of the curved lower surface 90b, the distance between the center of the aperture 80b, i.e., the pivot point of the guide 34b, and the webbing guide portion 112b increases. This increased distance helps to reduce the tendency of the seat belt webbing 16 to dump. The curved configuration of the webbing guide portion 112b, when conforming to the curved lower surface 90b, also reduces the tendency of the seat belt webbing 16 to slide toward the end portions 114b and 116b of the insert 110b so as to further reduce the tendency of the seat belt webbing to dump. Additionally, the deformation of the insert 110b and the seat belt webbing 16 into the angled grooves 134 of the support member 50b helps to reduce the tendency of the seat belt webbing to dump by increasing the resistance to movement of the seat belt webbing toward the end portions 114b and 116b of the insert 10b.

When the load applied to the seat belt webbing 16 decreases, the load applied to the insert 110b of the guide 34b also decreases. When the load applied to the insert 110b is reduced below the predetermined amount, the resiliency of the insert 110b causes the insert to return to its original shape within the elongated slot 88b.

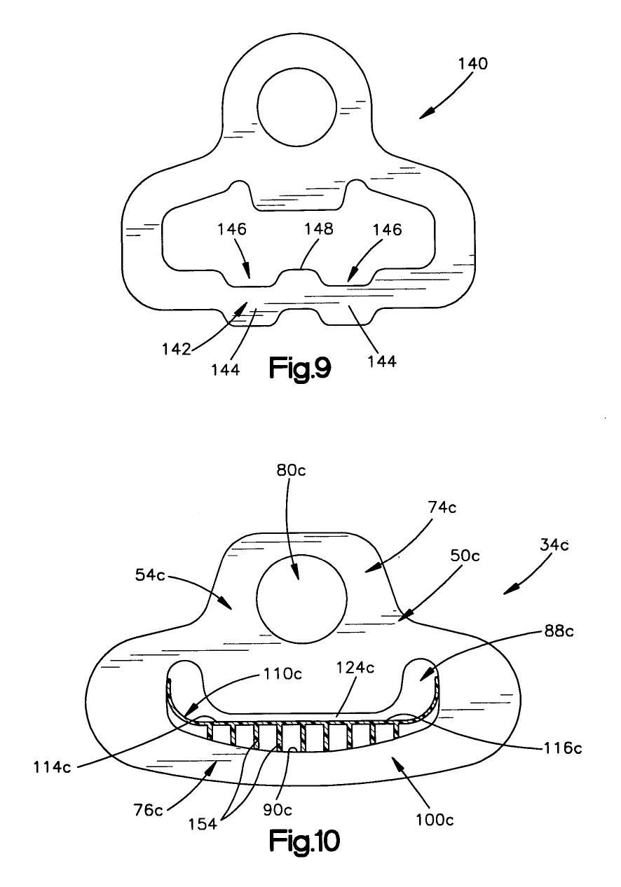

FIG. 9 illustrates an alternative metal base plate 140 that may be used with the guide 34b of FIG. 7. The guide bar portion 142 of the metal base plate 140 includes two undulations 144. The undulations 144 define grooves 146 along an upper surface 148 of the guide bar portion 142. When the metal base plate 140 of FIG. 9 is used in the support member 50b of the guide 34b of FIG. 7, the guide bar portion 100b of the plastic covering 54b includes only two angled grooves 134. The angled grooves 134 pass through the grooves 146 in the guide bar portion 142 of the metal base plate 140. As a result, the angled grooves 134 may be deeper than those shown and described with reference to FIGS. 7 and 8.

FIG. 10 is an elevation view, partially in section, of a guide 34c constructed in accordance with a third embodiment of the present invention. The guide 34c may form the guide 34 of the seat belt system 10 illustrated in FIG. 1. The guide 34c is similar to the guide 34a. Features of the guide 34c that are the same as or similar to those described with reference the guide 34a of FIGS. 2-6 are labeled with the same reference numbers with the addition of the suffix “c”.

The guide 34c includes a support member 50c. The support member 50c of the guide 34c is adapted to withstand extremely high loads and to maintain structural integrity at temperature extremes. The support member 50c is similar to the support member 50 of FIGS. 2-6 and includes a metal base plate (not shown) and a plastic covering 54c. The plastic covering 54c of the support member 50c is preferably insert molded onto the metal base plate and includes a mounting portion 74c and a webbing support portion 76c.

An aperture 80c extends through the mounting portion 74c of the plastic covering 54c. The aperture 80c is sized for receiving a fastener (not shown) for pivotally mounting the guide 34c to the vehicle 14. The webbing support portion 76c of the plastic covering 54c defines an elongated slot 88c of the support member 50c. The elongated slot 88c includes a curved lower surface 90c. The curved lower surface 90c has a radius of curvature that is significantly greater than the distance between the curved lower surface and the center of the aperture 80′c. The curved lower surface 90c extends across the width of the support member 50c, from left to right as viewed in FIG. 10, and defines the lowermost portion of the elongated slot 88c. The curved lower surface 90c forms an uppermost surface of a guide bar portion 100c of the plastic covering 54c.

The insert 110c of the guide 34c of FIG. 10 includes ribs 154 that extend downwardly, as viewed in FIG. 10, from the webbing guide portion 112c. The ribs 154 are spaced apart from one another along the insert 110c. The ribs 154 located near the center of the webbing guide portion 112c extend farther away from the webbing guide portion than the ribs located near the end portions 114c and 116c of the insert 110c.

When the insert 110c is received in the elongated slot 88c of the support member 50c, the lowermost end of each rib 154 contacts the curved lower surface 90c. Under normal operating conditions, the ribs 154 add stiffness to the insert 110c to help to maintain the channel 124c. The thickness, shape, and pattern of the ribs 154 may be tuned for collapsing at a predetermined load. When subjected to the predetermined load, the ribs 154 collapse and the webbing guide portion 112c of the insert 110c conforms to the curved lower surface 90c, in a manner similar to that described with reference to FIGS. 2-6.

FIG. 11 is an exploded perspective view of a guide 34d constructed in accordance with a fourth embodiment of the present invention. The guide 34d may form the guide 34 of the seat belt system 10 illustrated in FIG. 1. The guide 34d is similar to the guide 34a of FIGS. 2-6. Features of the guide 34d that are the same as or similar to those described with reference to the guide 34a of FIGS. 2-6 are labeled with the same reference numbers with the addition of the suffix “d”.

The support member 50d of the guide 34d of FIG. 11 is similar to the support member 50 of the guide 34a of FIGS. 2-6 with the exception that, instead of including recesses in the guide bar portion 10d, the support member 50d includes two cylindrical alignment pins 160 that extend outward of the outer surface 84d of the plastic covering 54d in the region between the aperture 80d and the elongated slot 88d. The two alignment pins 160 are spaced apart from one another longitudinally along the elongated slot 88d.

The insert 110d of the guide 34d of FIG. 11 includes an upper wall portion 164. The upper wall portion 164 connects the curved end portions 114d and 116d at a location spaced above, as viewed in FIG. 11, the webbing guide portion 112d. As a result, the insert 110d of the guide 34d is a complete loop that defines an elongated slot 170 for receiving the seat belt webbing 16.

As shown in FIG. 11, the upper wall portion 164 of the insert 110d includes two upwardly extending protrusions 174. The two protrusions 174 are spaced apart from one another longitudinally along the slot 170. Each of the protrusions 174 includes a circular mating hole 176 (FIG. 11). The mating hole 176 of each protrusion 174 is sized for receiving an alignment pin 160 of the support member 50d.

When the insert 110d is received in the elongated slot 88d of the support member 50d, each alignment pin 160 is received in a different one of the mating holes 176. The alignment pins 160 help to provide proper alignment between the insert 110d and the support member 50d and also help to maintain the insert relative to the support member when the insert is subjected to a load from the seat belt webbing 16.

The webbing guide portion 112d of the insert 110d provides a low friction surface over which the seat belt webbing 16 moves. When the seat belt webbing 16 applies a load in excess of a predetermined amount to the webbing guide portion 112d of the insert 110d, the webbing guide portion 112d deforms. During deformation, the webbing guide portion 112d conforms to the shape of the curved lower surface 90d, as shown in FIG. 13. When the webbing guide portion 112d conforms to the shape of the curved lower surface 90d, dumping of the seat belt webbing 16 is less likely to occur.

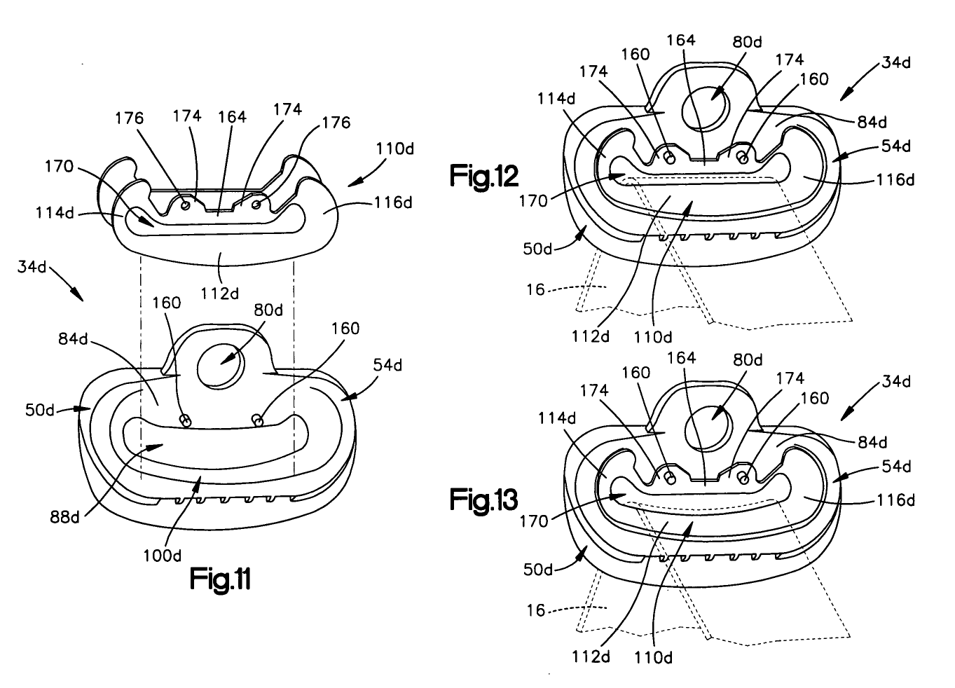

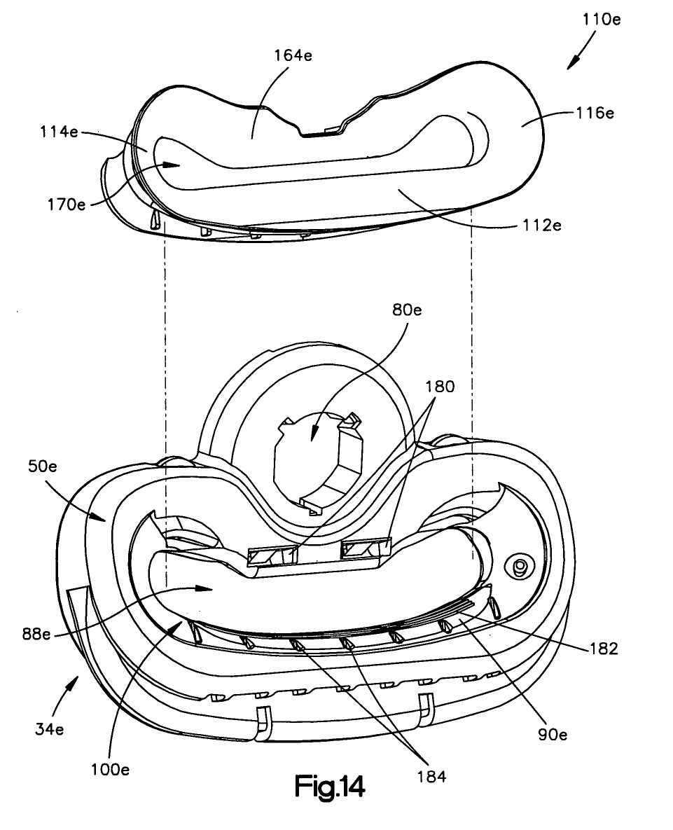

FIG. 14 is an exploded perspective view of a guide 34e constructed in accordance with a fifth embodiment of the present invention. The guide 34e may be the guide 34 of the seat belt system 10 illustrated in FIG. 1. The guide 34e of FIGS. 14-18 is similar to the guide 34d of FIGS. 11-13. Features of the guide 34e that are the same as or similar to those described with reference to the guide 34 of FIGS. 2-6 are labeled with the same reference numbers with the addition of the suffix “e”.

The support member 50e of the guide 34e of FIG. 14 is similar to the support member 50d of the guide 34d of FIGS. 11-13 with the exception that, instead of including cylindrical alignment pins 160 in the guide bar portion 100e, the support member 50e includes at least one recess 180 in the region between the aperture 80e and the elongated slot 88e. The two recesses 180 shown in FIG. 14 are spaced apart from one another longitudinally along the elongated slot 88e.

Multiple thin slot ribs 182 extend from the curved lower surface 90e of the elongated slot 88e. The slot ribs 182 extend in a direction generally perpendicular to the direction that the seat belt webbing 16 extends over the curved lower surface 90e.

In addition, multiple slot recesses 184 extend into the curved lower surface 90e of the elongated slot 88e, preferably adjacent the outside ones of the slot ribs 182. The slot recesses 184 are spaced apart from one another longitudinally along the elongated slot 88e.

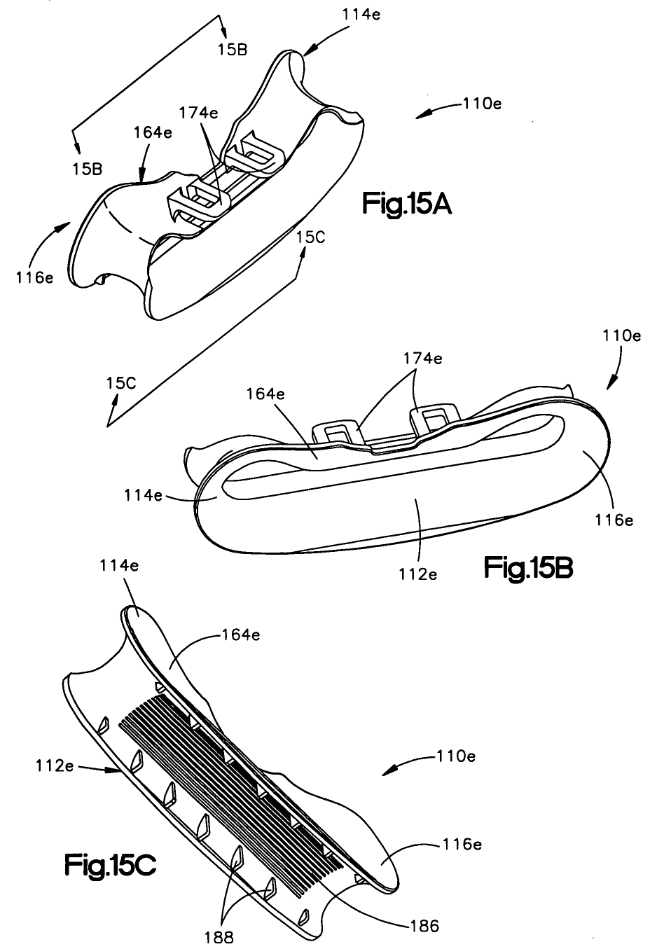

The insert 110e of the guide 34e of FIG. 14 is shown in greater detail and from various angles in the views of FIGS. 15A-15C. The insert 110e includes an upper wall portion 164e. The upper wall portion 164e connects the curved end portions 114e and 116e at a location spaced above, as viewed in FIG. 14, the webbing guide portion 112e. As a result, the insert 110e of the guide 34e is a complete loop that defines an elongated slot 170e for receiving the seat belt webbing 16. Portions of the insert 110e may be shaped to compress slightly during engagement with the support member 50e. In such case, natural expansion of the insert 110e upon complete engagement will exert pressure on the surface defining the elongated slot 88e to connect the insert 110e firmly with the support member 50e.

As shown best in FIGS. 15A and 15B, the upper wall portion 164e of the insert 110e includes two inwardly extending protrusions 174e. The two protrusions 174e are spaced apart from one another longitudinally along the slot 88e. Each of the protrusions 174e is sized and shaped to engage with an aperture 180 of the support member 50e. The engagement between the protrusion 174e and the aperture 180 may be accomplished via an interference fit, an adhesive, a mechanical fastener, or any other suitable method.

When the protrusions 174e are received in the apertures 180 of the support member 50e, each protrusion 174e is received in a different one of the apertures 180. The protrusions 174e help to provide proper alignment between the insert 110e and the support member 50e and also help to maintain the insert 110e in position relative to the support member 50e when the insert 110e is subjected to a load from the seat belt webbing 16.

The insert 110e of the guide 34e of FIG. 14 also includes multiple insert ribs 186 that extend downwardly, in the orientation of FIG. 14, from the webbing guide portion 112e. The insert ribs 186, shown best in FIG. 15C, extend longitudinally with respect to the insert 110e. The insert ribs 186 may be adapted to mate selectively with the slot ribs 182, when present, in an intermeshing arrangement.

Multiple insert protrusions 188 extend downwardly, in the orientation of FIG. 14, from the webbing guide portion 112e. The insert protrusions 188, shown best in FIG. 15C, extend generally perpendicularly with respect to the insert ribs 186 and are spaced apart from the insert ribs 186. The insert protrusions 188 may be adapted to mate selectively with the slot recesses 184 of the support member 50e. Optionally, either or both of the insert ribs 186 and insert protrusions 188 may function similarly to the ribs 154 described with reference to the third embodiment of the present invention and shown in FIG. 10. Also, elements similar to the insert protrusions 188 and slot recesses 184, respectively, may be provided on the other one of the insert and slot.

When the seat belt webbing 16 applies a load in excess of a predetermined amount to the webbing guide portion 112e of the insert 110e, the webbing guide portion 112e deforms as shown in FIGS. 17 and 18. During deformation, the webbing guide portion 112e conforms to the shape of the curved lower surface 90e. As shown in FIG. 18, when the insert 110e conforms to the shape of the curved lower surface 90e, the insert ribs 186 engage with the slot ribs 182 and the insert protrusions 188 engage with the slot recesses 184.

When the webbing guide portion 112e moves downward to conform to the shape of the curved lower surface 90e, the distance between the center of the aperture 80e, i.e., the pivot point of the guide 34e, and the webbing guide portion 112e increases. This increased distance helps to reduce the tendency of the seat belt webbing 16 to dump. The curved configuration of the webbing guide portion 112e, when conforming to the curved lower surface 90e, also reduces the tendency of the seat belt webbing 16 to slide toward the end portions 114e and 116e of the insert 110e so as to further reduce the tendency of the seat belt webbing 16 to dump. Additionally, the engagement of the insert ribs 186 into the slot ribs 182 of the support member 50e and of the insert protrusions 188 into the slot recesses 184 of the support member 50b helps to reduce the tendency of the seat belt webbing to dump by increasing the resistance to movement of the insert 110e and the seat belt webbing 16 toward the end portions 114e and 116e of the insert 110e.

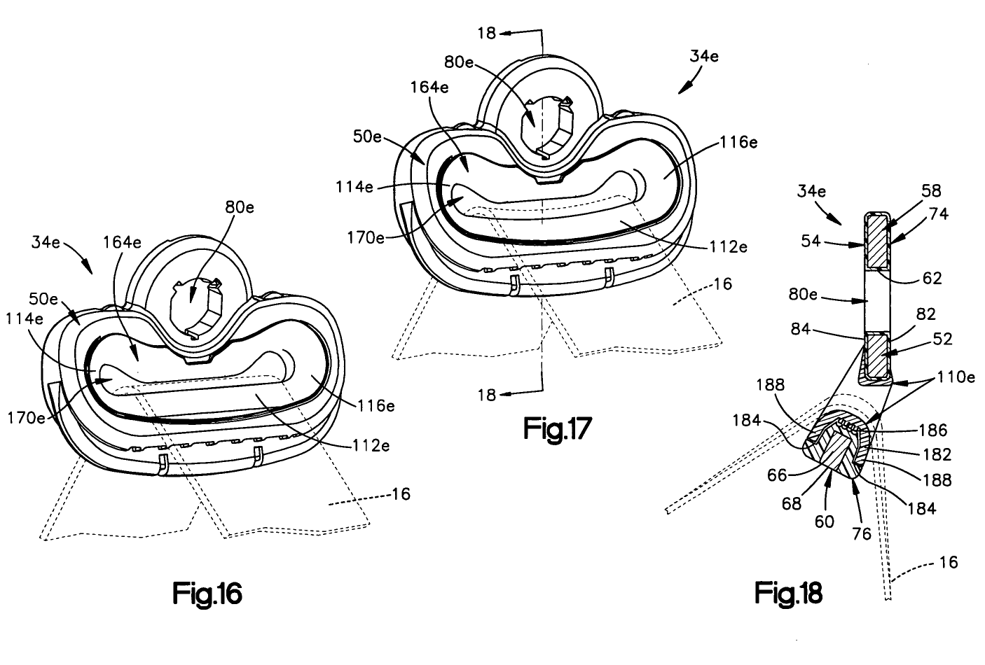

When the load applied to the seat belt webbing 16 decreases, the load applied to the insert 110e of the guide 34e also decreases. When the load applied to the insert 110e is reduced below the predetermined amount, the resiliency of the insert 110e causes the insert to return to its original shape within the elongated slot 88e, as shown in FIG. 16.

From the above description of the invention, those skilled in the art will perceive improvements, changes and modifications. For example, the guide 34d of FIGS. 11-13 may be modified to include angled grooves similar to those shown with reference to FIGS. 7 and 8 or ribs similar to those shown with reference to FIG. 10, or the slot and insert ribs 182 and 186, slot recesses 184, and insert protrusions 188 of FIGS. 14-18 may each be provided on one or both of the insert 110e and support member 50e. Such improvements, changes and modifications within the skill of the art are intended to be covered by the appended claims.

Having described the invention, the following is claimed:

1. A guide for seat belt webbing in a vehicle, the guide comprising:
a support member adapted to be mounted to the vehicle and including an elongated slot through which the seat belt webbing extends, a curved surface defining a portion of the elongated slot; and
an insert adapted to be received in the elongated slot of the support member and including a webbing guide portion for guiding the seat belt webbing through the elongated slot, the webbing guide portion, during normal operating conditions, being spaced apart from the curved surface of the support member,
the webbing guide portion of the insert, when subjected to a load from the seat belt webbing that exceeds a predetermined amount, moving into engagement with and conforming to the curved surface of the support member.

2. The guide of claim 1 wherein the curved surface defines a lowermost edge of the elongated slot.

3. The guide of claim 1 wherein the support member has a mounting aperture with a center and wherein the curved surface has a radius of curvature that is greater than a distance between the curved surface and the center of the mounting aperture.

4. The guide of claim 1 wherein the webbing guide portion of the insert, under normal operating conditions, is oriented to extend along and through the elongated slot.

5. The guide of claim 4 wherein the webbing guide portion of the insert is interposed between end portions of the insert, the end portions of the insert overlying portions of the support member at opposite ends of the elongated slot for supporting the insert within the elongated slot.

6. The guide of claim 1 wherein the insert and the support member include interconnecting portions for securing the insert relative to the support member.

7. The guide of claim 6 wherein the interconnecting portions include a guide bar portion of the support member with recesses and legs of the insert that extend into the recesses.

8. The guide of claim 6 wherein the interconnecting portions include alignment pins on the support member and associated mating holes formed in a portion of the insert.

9. The guide of claim 8 wherein the associated mating holes are formed in an upper wall portion of the insert, the upper wall portion of the insert being spaced apart from the webbing guide portion of the insert.

10. The guide of claim 1 wherein the insert is formed from a low friction and generally resilient material, the webbing guide portion of the insert returning to a location spaced apart from the curved lower surface of the support member when the load decreases below the predetermined amount subsequent to exceeding the predetermined amount.

11. The guide of claim 1 wherein a plurality of grooves extend into the curved surface of the support member, portions of the webbing guide portion deforming into the grooves when the conforming to the curved surface in response to the load from the seat belt webbing exceeding the predetermined amount.

12. The guide of claim 1 wherein the insert includes structures that extend between the webbing guide portion and the curved surface of the support member when the insert is received in the elongated slot, the structures adding stiffness to the webbing guide portion of the insert.

13. The guide of claim 12 wherein the structures include a plurality of ribs, the ribs collapsing to enable the webbing guide portion to conform to the curved surface of the support member when the load from the seat belt webbing exceeds the predetermined amount.

14. The guide of claim 13 wherein the webbing guide portion of the insert is interposed between end portions of the insert, the ribs located near a center of the webbing guide portion extending farther away from the webbing guide portion than the ribs adjacent the end portions.

15. The guide of claim 1 wherein the insert forms a complete loop that defines a slot for receiving the seat belt webbing.

16. The guide of claim 15 wherein an upper wall portion of the insert and a support portion of the support member include interconnecting portions for securing the insert relative to the support member.

17. The guide of claim 16 wherein the interconnecting portions include alignment pins on the support member and associated mating holes formed in the upper wall portion of the insert.

18. A guide for seat belt webbing in a vehicle, the guide comprising:
a support member adapted to be mounted to the vehicle and including an elongated slot through which the seat belt webbing extends; and
an insert adapted to be received in the elongated slot of the support member and including a webbing guide portion for guiding the seat belt webbing through the elongated slot, the webbing guide portion, during normal operating conditions, extending along and through the elongated slot so that the seat belt webbing extending through the elongated slot is generally flat, the webbing guide portion deforming into a curved configuration when subjected to a load from the seat belt webbing that exceeds a predetermined amount so that the seat belt webbing extending through the elongated slot also is curved.

19. The guide of claim 18 wherein the support member includes a curved surface that defines a lowermost edge of the elongated slot, the webbing guide portion conforming to the curved surface when deforming into the curved configuration.

20. The guide of claim 18 wherein the insert forms a complete loop that defines a slot for receiving the seat belt webbing.
